(19) United States
(12) Patent Application Publication
(10) Pub. No.: US 2017/0348994 A1
(43) Pub. Date: Dec. 7, 2017

(54) Invisible Luminescent Protection for Financial and Identification Documents

(71) Applicants: Vitaly Talyansky, Portland, OR (US); Edward Talyansky, Battle Ground, WA (US)

(72) Inventors: Vitaly Talyansky, Portland, OR (US); Edward Talyansky, Battle Ground, WA (US)

(21) Appl. No.: 15/170,009

(22) Filed: Jun. 1, 2016

(51) Int. Cl. B42D 25/382; H04N 5/225; B42D 25/29; B42D 25/24; B42D 25/23; G06K 9/00; H04N 5/33; G06T 7/00

(52) U.S. Cl. CPC B42D 25/382; H04N 5/33; H04N 5/2256; G06T 7/001; B42D 25/24; B42D 25/23; G06K 9/00469; B42D 25/29; G06T 2207/10048; G06T 2207/30176

(57) ABSTRACT

Methods and apparatus for invisible luminescent protection for financial and identification documents are described herein. An example apparatus includes an illuminating source to illuminate a sample with light having a first wavelength, a photo element to detect light having a second wavelength and to capture an image of a first pattern printed on the sample, wherein the first pattern is printed on a first area of the sample with clear ink containing inorganic, ceramic particles having a mean diameter of less than one micron and having luminescent properties such that when the particles are illuminated with light having the first wavelength, they emit light having the second wavelength.

### FIELD OF THE DISCLOSURE

The present disclosure relates generally to document security and, more particularly, to invisible luminescent protection for financial and identification documents.

### BACKGROUND

Checks and other documents that require filling variable data into preprinted fields are often manipulated by bad actors to alter the information written into the various fields by a process of check washing or other means. This type of fraud causes significant problems for those being defrauded.

### BRIEF DESCRIPTION OF THE DRAWINGS

FIG. 1 is a diagram of a blank check.

FIG. 2 is a diagram of check printed with invisible luminescent protection in accordance with the teachings of this disclosure.

FIG. 3 is a block diagram of a system to implement invisible luminescent protection in accordance with the teachings of this disclosure.

FIG. 4 is a flowchart representative of example machine readable instructions that may be executed to implement the example system to implement invisible luminescent protection of FIG. 3.

FIG. 5 is a block diagram of an example processing system capable of executing the example machine readable instructions of FIG. 4 to implement the example system to implement invisible luminescent protection of FIG. 3.

### DETAILED DESCRIPTION

Bank checks contain preprinted fields such as payee and dollar amount that are typically filled in by individuals writing in pen, usually with dye-based inks. Alternatively, checks and other documents can be filled in by use of a printer. In either case, if a criminal intercepts a check after it is filled out but before it is cashed, by stealing it from a mailbox for example, it is possible to remove the ink from the check by a process called check washing. This involves washing or submerging the check in acetone or another solvent to dissolve the dye based ink from one or more fields of the check. The criminal can then write his own values into those fields, such as increasing the amount and changing the payee to himself. If done well, there is little that a bank can do to ascertain that a check has been manipulated in such a manner and the bank will likely cash the check, thereby creating a windfall for the criminal at the expense of the innocent check issuer.

One way to prevent this type of check washing fraud is to include a security image or pattern on the check that would be altered during the check washing process. It would then be apparent that the check was adulterated by the change to the security image. However, the presence of a visible security image on a check would allow criminals to see it, which could potentially aid them in defeating the security measure. However, a security image that is invisible to the naked eye and can only be seen with special equipment would allow banks to determine if a check has been adulterated without the criminals noticing the security feature. This would allow check washing fraud to be readily detected while also creating a greater deterrent effect against this type of fraud.

An invisible security image can be printed on a check using fugitive invisible ink that will run when the check is adulterated using solvents or other methods of check washing. This invisible ink can be printed on particular areas of a check, such as the payee and dollar amount fields, in an image or a geometric pattern. The check can then be viewed with special equipment that allows the invisible ink to be seen to determine if one or more of the fields of the check have been adulterated. If the geometric pattern of the invisible ink has been changed, it will be apparent that the check has been attacked via some manner of check washing and appropriate action can be taken. This security ink can also be used in critical areas of other documents with fillable fields such as IDs, prescriptions, applications, certificates, visas, etc.

One way to create this security ink is to mix luminescent particles or taggants into the ink. Taggants that have luminescent properties emit light at a particular wavelength (the emission wavelength of the taggant) when they are illuminated by light at another particular wavelength (the excitation wavelength of the taggant). Once these taggants are mixed with ink, the ink will have the same luminescent properties as the taggants therein.

Example methods, apparatus, and/or articles of manufacture disclosed herein provide a method of determining if a check or other document has been subject to check washing or otherwise adulterated. In examples disclosed herein, inorganic ceramic particles (taggants) with a particle size of less than one micron are mixed with a clear, dye-based ink. In examples disclosed herein, this ink is printed on key areas of a check or other secure document in a particular geometric pattern. In examples disclosed herein, the check or other security document is then viewed with a camera device that illuminates the document with light at the excitation wavelength of the taggant and detects light at the emission wavelength of the taggant. In examples disclosed herein, if the geometric pattern originally printed on the document is viewable in its original form, it can be concluded that the document has not been adulterated. In examples disclosed herein, if the geometric pattern is missing or distorted, it can be determined that the document has been adulterated.

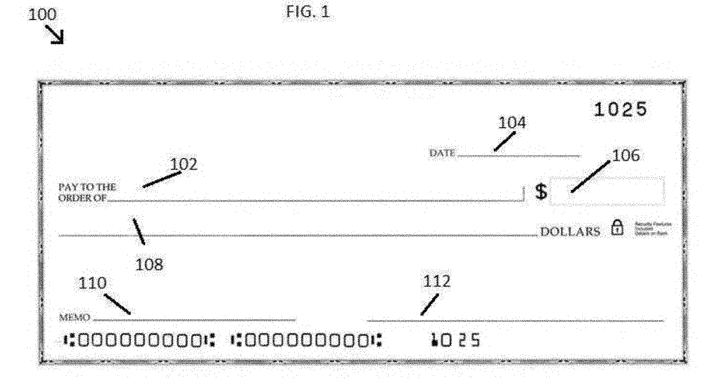

FIG. 1 is diagram of a blank check 100. The blank check 100 contains a payee field 102, a date field 104, a numeric amount field 106, a written amount field 108, a memo field 110 and a signature field 112. Each of these fields are filled out by the person writing the check. However, if a nefarious party apprehends the check 100 after these various fields are filled out but before the check 100 is cleared by a bank, one or more of the fields can be erased by washing the check with acetone or another solvent. The individual who washed the check can then rewrite the payee field 102 to themselves and increase the amount field 106 in order to defraud the check writer of a significant sum of money.

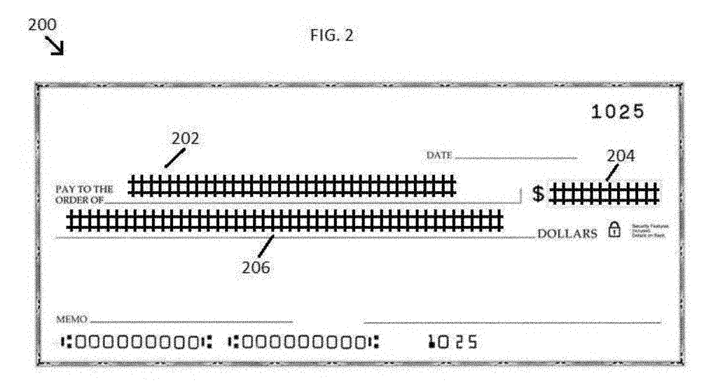

FIG. 2 is a diagram of a check 200 that contains invisible luminescent protection in accordance with the teachings of this disclosure. In the example of FIG. 2, fields 202, 204 and 206 of the check 200 are printed over with invisible security ink. In some examples, other fields of the check 200 may be printed with invisible security ink. The invisible security ink used to print over fields 202, 204 and 206 of FIG. 2 consists of clear, dye-based ink mixed with taggant. The taggant mixed with the dye-based ink consists of inorganic, ceramic particles with a mean diameter of less than one micron that are invisible to the naked eye. These inorganic, ceramic particles have luminescent properties such that when they are illuminated with light at one wavelength (the excitation wavelength of the taggant), they emit light at another wavelength (the emission wavelength of the taggant). Therefore, the taggant printed in fields 202, 204 and 206 of check 200 can be detected by illuminating those fields with light at the taggant's excitation wavelength and detecting the light emitted at the taggant's emission wavelength.

In the example of FIG. 2, invisible security ink is printed in fields 202, 204 and 206 in a particular geometric pattern. In some examples, the security ink may be printed in other patterns or images. Because the security ink is clear and the taggant is not visible to the naked eye, the security ink patterns 202, 204 and 206 of FIG. 2 will not be visible without special equipment and a check marked with security ink will not look any different than a check that is not so marked. Thus, a potential perpetrator of check fraud will not know of the presence of the security ink. Also, the example fields 202, 204 and 206 of the check will appear blank along with all other fields of the check so that an individual using the check can fill out all of the fields as normal. If the perpetrator later washes the check to remove the payee name, the dollar amount or any other data filled in on the check, the dye-based invisible security ink will be washed as well. Using a detection device, a bank employee can then illuminate the check with light at the taggant's excitation wavelength and view the luminescent emission at the taggant's emission wavelength to view the invisible security ink pattern. If the geometric pattern has been distorted or removed, the bank employee will know that the check has been adulterated and can take appropriate action.

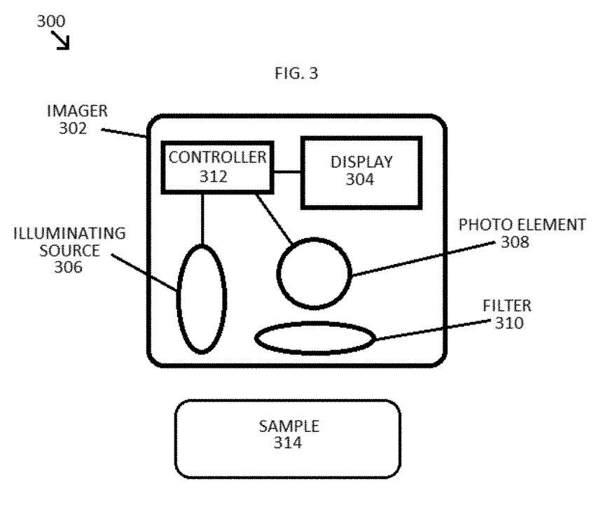

FIG. 3 is a block diagram of a system 300 for implementing invisible protection for checks. The example of FIG. 3 includes an imager 302 and a sample 314. The example imager 302 includes a display 304, an illuminating source 306, a photo element 308, a filter 310 and a controller 312.

The example display 304 displays an image of the invisible ink pattern printed on the example sample 314. The example display 304 receives input from the example controller 312 with the information of what image to display.

The example illuminating source 306 illuminates the example sample 314 with light at the excitation wavelength of the taggant in the invisible security ink printed on the sample 314. In the illustrated example, the illuminating source 306 is an array of light emitting diodes such that their illumination covers the entire area of the sample 314. In other examples, the illuminating source 306 may be one or more lasers or any other device or combination of devices capable of emitting light at the appropriate wavelength to illuminate the sample 314. In some examples, the illuminating source 306 only illuminates certain portions of the sample 314.

The example photo element 308 detects light emitted by the sample 314 at the excitation wavelength of the taggant contained in the invisible security ink printed on the example sample 212. In the illustrated example, the photo element 308 is a camera capable of detecting light at the emission wavelength of the taggant. In other examples, the photo element 308 may be any device capable of detecting light at the appropriate wavelength.

The example filter 310 allows light at the emission wavelength of the taggant in the sample 314 to pass but blocks light at other wavelengths. This ensures that the photo element 308 only detects light at the appropriate emission wavelength and that the display only displays the image or pattern printed on the sample 314 with the invisible security ink. The example filter 310 ensures that no light from the example illuminating source 306 or any other ambient light is detected by the example photo element 308.

The sample 314 is a document or physical device on which a pattern or image is printed with invisible security ink containing taggant. In the illustrated example, the sample 314 is a bank check. In some examples, the sample 314 may be another security document with fillable fields such as a passport or government form. In other examples, the sample 314 may be any document or device with security ink containing taggant printed on it.

While an example system for implementing invisible protection for checks has been illustrated in FIG. 3, one or more of the elements, processes and/or devices illustrated in FIG. 3 may be combined, divided, re-arranged, omitted, eliminated and/or implemented in any other way. Further, the example imager 302, the example display 304, the example illuminating source 306, the example photo element 308, the example filter 310, the example controller 312, the example sample 314 and/or, more generally, the example system for implementing invisible protection for checks may be implemented by hardware, software, firmware and/or any combination of hardware, software and/or firmware. Thus, for example, any of the example imager 302, the example display 304, the example illuminating source 306, the example photo element 308, the example filter 310, the example controller 312, the example sample 314 and/or, more generally, the example system for implementing invisible protection for checks could be implemented by one or more circuit(s), programmable processor(s), application specific integrated circuit(s) (ASIC(s)), programmable logic device(s) (PLD(s)), microprocessor(s), hardware processor(s), and/or field programmable logic device(s) (FPLD(s)), etc. When any of the system or apparatus claims of this patent are read to cover a purely software and/or firmware implementation, at least one of the example imager 302, the example display 304, the example illuminating source 306, the example photo element 308, the example filter 310, the example controller 312, the example sample 314 and/or, more generally, the example system for implementing invisible protection for checks is hereby expressly defined to include a tangible computer readable storage medium such as a memory, DVD, CD, Blu-ray, etc. storing the software and/or firmware. Further still, the example imager 302, the example display 304, the example illuminating source 306, the example photo element 308, the example filter 310, the example controller 312, the example sample 314 and/or, more generally, the example system for implementing invisible protection for checks may include more than one of any or all of the illustrated elements, processes and devices.

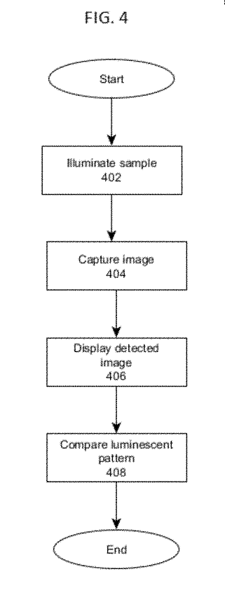

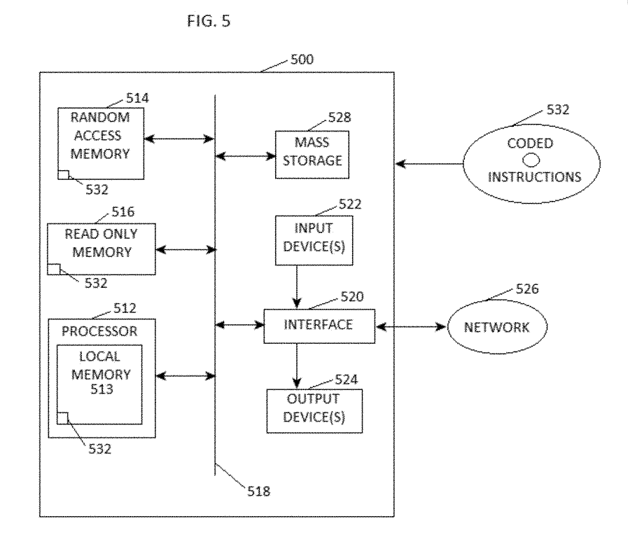

FIG. 4 is a flowchart representative of example machine readable instructions for implementing the example system 300 of FIG. 3. In the example flowchart of FIG. 4, the machine readable instructions comprise program(s) for execution by a processor such as the processor 512 shown in the example computer 500 discussed below in connection with FIG. 5. The program(s) may be embodied in software stored on a tangible computer readable storage medium such as a CD-ROM, a floppy disk, a flash drive, a hard drive, a digital versatile disk (DVD), a Blu-ray disk, or a memory associated with the processor 512, but the entire program and/or parts thereof could alternatively be executed by a device other than the processor 512 and/or embodied in firmware or dedicated hardware. Further, although the example program(s) is described with reference to the flowchart illustrated in FIG. 4, many other methods of implementing the example system 300 of FIG. 3 may alternatively be used. For example, the order of execution of the blocks may be changed, and/or some of the blocks described may be changed, eliminated, or combined.

As mentioned above, the example processes of FIG. 4 may be implemented using coded instructions (e.g., computer readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable storage medium is expressly defined to include any type of computer readable storage device and/or disk and to exclude propagating signals. Additionally or alternatively, the example processes of FIG. 4 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable storage medium is expressly defined to include any type of computer readable storage device and/or disk and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

FIG. 4 begins when the example illuminating source 306 illuminates the example sample 314 with light at a wavelength equal to the excitation wavelength of the taggant contained in the security ink that is printed on the sample 314 (block 402). In the illustrated example, the excitation wavelength of the taggant is in the infrared portion of the electromagnetic spectrum. In other examples, the taggant may have an excitation wavelength in other portions of the electromagnetic spectrum. In the illustrated example, the sample 314 is a check and the illuminating source 306 illuminates the entire sample 314. In other examples, the sample 314 may be another item or document and the illuminating source 306 may only illuminate certain portions of the sample 314.

When the example illuminating source 306 illuminates the example sample 314 with light at the appropriate wavelength, the taggant in the sample 314 emits a luminescent response at the taggant's emission wavelength. In the illustrated example, the taggant's emission wavelength is in the infrared portion of the electromagnetic spectrum. In other examples, the taggant may have an emission wavelength in other portions of the electromagnetic spectrum. The luminescent emission of the taggant in the example sample 314 passes through the example filter 310 and illuminates the example photo element 308. The example photo element 308 then captures an image of the taggant printed on the example sample 314 from the light that is emitted by the sample 314 (block 404).

After the example photo element 308 captures an image of the taggant printed on the example sample 314, the example controller 312 causes the image to be displayed on the example display 304 (block 406). This allows a user of the example imager 302 to view the invisible security ink pattern printed on the example sample 314.

After the image captured from the example sample 314 is displayed on the example display 304 (block 406), the displayed image is compared against the known invisible security ink pattern printed on the example sample 314 (block 408). In the illustrated example, a user of the imager 302 compares the displayed image to the known pattern printed on the sample 314 with security ink. In some examples, the controller 312 automatically compares the known pattern printed on the sample 314 to the image detected by the photo element 308 using image processing software. A determination as to whether the sample has been adulterated can be determined based upon this comparison. If the image detected by the example photo element 308 is substantially the same as the known image printed on the example sample 314, it can be determined that the sample 314 has not been adulterated. If the image detected by the example photo element 308 is substantially different from the known image printed on the example sample 314, it can be determined that the sample has been altered. The example of FIG. 4 then ends.

FIG. 5 is a block diagram of a processor platform 500 capable of executing the instructions of FIG. 4 to implement the example system for implementing invisible check protection 100 of FIG. 1. The processor platform 500 can be, for example, a server, a personal computer, an Internet appliance, a DVD player, a CD player, a Blu-ray player, a gaming console, a personal video recorder, a smart phone, a tablet, a printer, or any other type of computing device.

The processor platform 500 of the instant example includes a processor 512. As used herein, the term “processor” refers to a logic circuit capable of executing machine readable instructions. For example, the processor 512 can be implemented by one or more microprocessors or controllers from any desired family or manufacturer.

The processor 512 includes a local memory 513 (e.g., a cache) and is in communication with a main memory including a volatile memory 514 and a non-volatile memory 516 via a bus 518. The volatile memory 514 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 516 may be implemented by flash memory and/or any other desired type of memory device. Access to the main memory 514, 516 is controlled by a memory controller.

The processor platform 500 also includes an interface circuit 520. The interface circuit 520 may be implemented by any type of interface standard, such as an Ethernet interface, a universal serial bus (USB), and/or a PCI express interface.

One or more input devices 522 are connected to the interface circuit 520. The input device(s) 522 permit a user to enter data and commands into the processor 512. The input device(s) can be implemented by, for example, a keyboard, a mouse, a touchscreen, a track-pad, a trackball, isopoint and/or a voice recognition system.

One or more output devices 524 are also connected to the interface circuit 520. The output devices 524 can be implemented, for example, by display devices (e.g., a liquid crystal display, a cathode ray tube display (CRT), a printer and/or speakers). The interface circuit 520, thus, typically includes a graphics driver card.

The interface circuit 520 also includes a communication device such as a modem or network interface card to facilitate exchange of data with external computers via a network 526 (e.g., an Ethernet connection, a digital subscriber line (DSL), a telephone line, coaxial cable, a cellular telephone system, etc.).

The processor platform 500 also includes one or more mass storage devices 528 for storing software and data. Examples of such mass storage devices 528 include floppy disk drives, hard drive disks, compact disk drives and digital versatile disk (DVD) drives.

The coded instructions 532 of FIG. 5 may be stored in the mass storage device 528, in the volatile memory 514, in the non-volatile memory 516, and/or on a removable storage medium such as a CD or DVD.

Although certain example apparatus, methods, and articles of manufacture have been disclosed herein, the scope of coverage of this patent is not limited thereto. On the contrary, this patent covers all apparatus, methods, and articles of manufacture fairly falling within the scope of the claims of this patent.

What is claimed is:

1. An apparatus comprising:
an illuminating source to illuminate a sample with light having a first wavelength;
a photo element to detect light having a second wavelength and to capture an image of a first pattern printed on the sample, wherein the first pattern is printed on a first area of the sample with clear ink containing inorganic, ceramic particles having a mean diameter of less than one micron and having luminescent properties such that when the particles are illuminated with light having the first wavelength, they emit light having the second wavelength.

2. The apparatus of claim 1, wherein the sample is a check and the first area is a fillable field of the check.

3. The apparatus of claim 1, wherein the first wavelength is in the infrared portion of the electromagnetic spectrum.

4. The apparatus of claim 1, wherein the second wavelength is in the infrared portion of the electromagnetic spectrum.

5. The apparatus of claim 1, further comprising a filter adjacent to the photo element, wherein the filter passes light having the second wavelength and substantially blocks light having any other wavelength.

6. The apparatus of claim 1, further comprising a display to display the captured image of the first pattern.

7. A method comprising:
illuminating a sample with light having a first wavelength;
detecting light having a second wavelength emitted by the sample; and
capturing an image of a first pattern printed on the sample, wherein the first pattern is printed on a first area of the sample with clear ink containing inorganic, ceramic particles having a mean diameter of less than one micron and having luminescent properties such that when the particles are illuminated with light having the first wavelength, they emit light having the second wavelength.

8. The method of claim 7, further comprising displaying the captured image of the first pattern.

9. The method of claim 7, further comprising performing a first comparison between the captured image of the first pattern and a second pattern and determining a characteristic of the sample based on the first comparison.

10. The method of claim 7, further comprising passing detected light through a filter that blocks light at any wavelength other than the second wavelength.

11. The method of claim 7, wherein the first wavelength is in the infrared portion of the electromagnetic spectrum.

12. The method of claim 7, wherein the second wavelength is in the infrared portion of the electromagnetic spectrum.

13. The method of claim 7, wherein the sample is a check and the first area of the sample is a Tillable field on the check.

14. A tangible machine readable storage medium comprising instructions that, when executed, cause a machine to at least:
illuminate a sample with light having a first wavelength;
detect light having a second wavelength emitted by the sample; and
capture an image of a first pattern printed on the sample, wherein the first pattern is printed on a first area of the sample with clear ink containing inorganic, ceramic particles having a mean diameter of less than one micron and having luminescent properties such that when the particles are illuminated with light having the first wavelength, they emit light having the second wavelength.

15. The storage medium of claim 14, wherein the instructions further cause the machine to display the captured image of the first pattern.

16. The storage medium of claim 14, wherein the instructions further cause the machine to perform a first comparison between the captured image of the first pattern and a second pattern and determine a characteristic of the sample based on the first comparison.

17. The storage medium of claim 14, wherein the instructions further cause the machine to pass detected light through a filter that blocks light at any wavelength other than the second wavelength.

18. The storage medium of claim 14, wherein the first wavelength is in the infrared portion of the electromagnetic spectrum.

19. The storage medium of claim 14, wherein the second wavelength is in the infrared portion of the electromagnetic spectrum.

20. The storage medium of claim 14, wherein the sample is a check and the first area of the sample is a Tillable field of the check.
